(19) United States
(12) Patent Application Publication
(10) Pub. No.: US 2025/0089108 A1
(43) Pub. Date: Mar. 13, 2025

(54) COMMUNICATION METHOD, AND DEVICES

(71) Applicant: GUANGDONG OPPO MOBILE TELECOMMUNICATIONS CORP., LTD., Dongguan (CN)

(72) Inventors: Haorui YANG, Dongguan (CN); Yang XU, Dongguan (CN); Fei LU, Dongguan (CN)

(21) Appl. No.: 18/958,076

(22) Filed: Nov. 25, 2024

Related U.S. Application Data
(63) Continuation of application No. PCT/CN2022/096363, filed on May 31, 2022.

(51) Int. Cl. H04W 76/10; H04W 12/06

(52) U.S. Cl. CPC H04W 76/10; H04W 12/068

(57) ABSTRACT

The present application relates to a communication method and devices. A first method includes a processor and a memory, where the memory is configured to store a computer program, the processor is configured to call the computer program stored in the memory and run the computer program, to cause the first device to perform: receiving first service information transmitted by a second device, where the second device is one of one or more authorized first-type devices; and transmitting, through a session of a first service, the first service information to a network device.

### CROSS-REFERENCE TO RELATED APPLICATION

This application is a Continuation application of International Application No. PCT/CN2022/096363 filed on May 31, 2022, which is incorporated herein by reference in its entirety.

### TECHNICAL FIELD

Embodiments of the present application relate to the field of communications, and in particular to, a communication method, and devices.

### BACKGROUND

A zero power consumption communication network belongs to a kind of wireless communication technology which is suitable for short distance and low rate. A zero power consumption device can convert external energy into electricity to support its own operations. Some requirements supporting the zero power consumption device accessing a network appear in a 5G system. How to better adapt to characteristics of the zero power consumption device, such as a passive zero power consumption device, and make the zero power consumption device communicate with the network become a problem to be solved.

### SUMMARY

The embodiments of the present application provide a communication method and devices.

The embodiments of the present application provide a communication method, including:
receiving, by a first device, first service information transmitted by a second device, where the second device is one of one or more authorized first-type devices; and
transmitting, by the first device through a session of a first service, the first service information to a network device.

The embodiments of the present application provide a communication method, including:
receiving, by a network device through a session of a first service, first service information transmitted by a second device from a first device, where the second device is one of one or more authorized first-type devices.

The embodiments of the present application provide a communication method, including:
transmitting, by a second device, first service information to a first device, where the first service information is transmitted by the first device to a network device through a session of a first service, where the second device is one of one or more authorized first-type devices.

The embodiments of the present application embodiment provide a first device, including:
a first communication unit, configured to receive first service information transmitted by a second device, and transmit the first service information to a network device through a session of a first service; where the second device is one of one or more authorized first-type devices.

The embodiments of the present application provides a network device, including:
a second communication unit, configured to receive first service information transmitted by a second device from a first device through a session of a first service; where the second device is one of one or more authorized first-type devices.

The embodiments of the present application provide a second device, including:
a third communication unit, configured to transmit first service information to a first device; where the first service information is transmitted by the first device to a network device through a session of a first service, the second device is one of one or more authorized first-type devices.

The embodiments of the present application provides a first device, including a processor and a memory, where the memory is configured to store a computer program, the processor is configured to call the computer program stored in the memory and run the computer program, to cause the first device to perform the above-mentioned communication method.

The embodiments of the present application provide a network device, including a processor and a memory, where the memory is configured to store a computer program, the processor is configured to call the computer program stored in the memory and run the computer program, to cause the network device to perform the above-mentioned communication method.

The present application provides a second device, including a processor and a memory, where the memory is configured to store a computer program, the processor is configured to call the computer program stored in the memory and run the computer program, to cause the second device to perform the above-mentioned communication method.

The embodiments of the present application provide a chip for implementing the above-mentioned communication methods.

In some embodiments, the chip including: a processor configured to call a computer program from a memory and run the computer program, to cause a device equipped with the chip to perform the above-mentioned communication methods.

The embodiments of the present application provide a non-transitory computer-readable storage medium, configured to store a computer program, where the computer program, when executed on a device, causes the device to perform the above-mentioned communication methods.

The embodiments of the present application provide a computer program product, including computer program instructions, where the computer program instructions cause a computer to perform the above-mentioned communication methods.

The embodiments of the present application provide a computer program, where the computer program, when executed on a computer, causes the computer to perform the above-mentioned communication methods.

The embodiments of the present application provides a communication system, including:
a first device, configured to perform the above-mentioned communication method;
a network device, configured to perform the above-mentioned communication method; and
a second device, configured to perform the above-mentioned communication method.

### BRIEF DESCRIPTION OF THE DRAWINGS

FIG. 1 is a schematic diagram of an application scenario according to embodiments of the present application.

FIG. 2 is a schematic diagram of a zero power consumption communication system.

FIG. 3 is a schematic diagram of an exemplary 5G network system architecture.

FIG. 4 is a schematic flowchart of a communication method according to an embodiment of the present application.

FIG. 5 is a schematic flowchart of a communication method according to another embodiment of the present application.

FIG. 6 is a schematic flowchart of a communication method according to yet another embodiment of the present application.

FIG. 7 is a schematic diagram of a protocol stack of a PC5 interface according to an embodiment of the present application.

FIG. 8 is a schematic flowchart of a communication method according to embodiments of the present application.

FIG. 9 is a schematic block diagram of a first device according to an embodiment of the present application.

FIG. 10 is a schematic block diagram of a network device according to an embodiment of the present application.

FIG. 11 is a schematic block diagram of a second device according to an embodiment of the present application.

FIG. 12 is a schematic block diagram of a communication device according to embodiments of the present application.

FIG. 13 is a schematic block diagram of a chip according to embodiments of the present application.

FIG. 14 is a schematic block diagram of a communication system according to embodiments of the present application.

### DETAILED DESCRIPTION

Technical solutions in the embodiments of the present application will be described below with reference to the accompanying drawings in the embodiments of the present application.

The technical solutions of embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), wireless local area networks (WLAN), wireless fidelity (Wi-Fi), a 5th-generation (5G) communication system, or other communication systems.

Generally speaking, traditional communication systems support a limited quantity of connections, which is easy to be implemented. However, with development of the communication technology, mobile communication systems will not only support traditional communication, but also support, for example, device to device (D2D) communication, machine to machine (M2M) communication, machine type communication (MTC), vehicle to vehicle (V2V) communication, vehicle to everything (V2X) communication or the like. The embodiments of the present application may be applied to these communication systems as well.

In an implementation, the communication systems in the embodiments of the present application may be applied to a carrier aggregation (CA) scenario, a dual connectivity (DC) scenario, and may also be applied to a standalone (SA) network deployment scenario.

In an implementation, the communication system in the embodiments of the present application may be applied to an unlicensed spectrum, and the unlicensed spectrum may also be considered as a shared spectrum. Alternatively, the communication system in the embodiments of the present application may be applied to a licensed spectrum, and the licensed spectrum may be considered as an unshared spectrum.

In the embodiments of the present application, each embodiment will be described in conjunction with a network device and a terminal device. The terminal device may be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (ST) in the WLAN, which may be a cellular phone, a cordless phone, a session initiation protocol (SIP) phone, a wireless local loop (WLL) station, a personal digital assistant (PDA) device, a handheld device with wireless communication functions, a computing device or another processing device connected to a wireless modem, an in-vehicle device, a wearable device, a terminal device in a next generation communication system (e.g., an NR network), a terminal device in a future evolved public land mobile network (PLMN) network, or the like.

In the embodiments of the present application, the terminal device may be deployed on land including indoor or outdoor, handheld, wearable, or in-vehicle; alternatively, the terminal device may be deployed on water (e.g., on a steamship); alternatively, the terminal device may be deployed in air (e.g., on an airplane, on a balloons, or on a satellite).

In the embodiments of the present application, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

As an example but not a limitation, in the embodiments of the present application, the terminal device may be a wearable device. The wearable device may be referred to as a wearable smart device, which is a general term of wearable devices developed by intelligent design and development on daily wear by applying wearable technology, such as glasses, gloves, watches, clothing and shoes. The wearable device is a portable device that is worn directly on a body, or integrated into clothes or accessories of users. The wearable device not only is a hardware device, but also implements powerful functions through software supporting as well as data interaction or cloud interaction. Generalized wearable smart devices includes devices that are fully functional, large in size, and may implement full or partial functions without relying on smart phones, such as a smart watch or smart glasses, as well as devices that only focus on a certain type of application functions and need to be used in conjunction with other devices (e.g., smart phones), such as various smart bracelets and smart jewelry that are used for monitoring physical signs.

In the embodiments of the present application, the network device may be a device used for communicating with a mobile device. The network device may be an access point (AP) in WLAN, a base station (Base Transceiver Station, BTS) in GSM or CDMA, or may also be a base station (NodeB, NB) in WCDMA, or may also be an evolutional base station (Evolutional Node B, eNB or eNodeB) in LTE, a relay station or an access point, an in-vehicle device, a wearable device, a network device (gNB) in an NR network, a network device in a future evolved public land mobile network (PLMN) network, a network device in an NTN network, or the like.

As an example but not a limitation, in the embodiments of the present application, the network device may have mobile characteristics. For example, the network device may be a mobile device. Optionally, the network device may be a satellite, or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, water, or other places.

In the embodiments of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell. The small cell here may include a metro cell, a micro cell, a pico cell, a femto cell, or the like. These small cells have characteristics of small coverage range and low transmission power, which are applicable for providing a data transmission service with high speed.

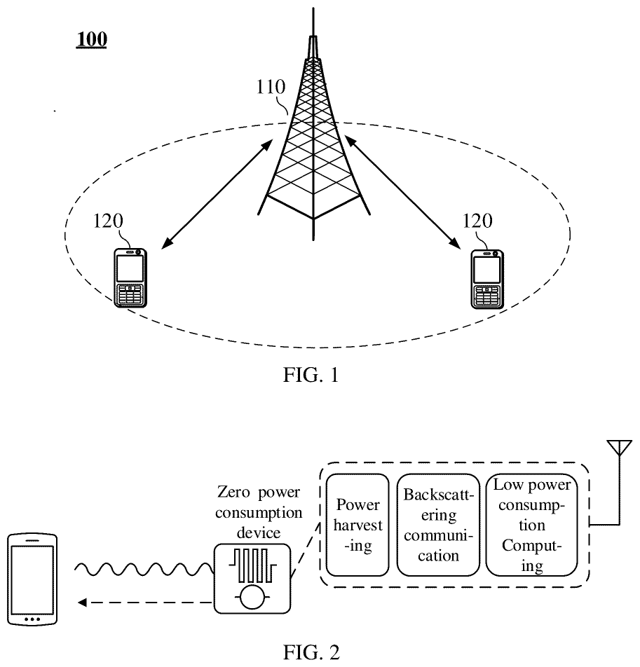

FIG. 1 exemplarily shows a communication system 100. The communication system includes a network device 110 and two terminal devices 120. In an implementation, the communication system 100 may include multiple network devices 110, and a coverage range of each network device 110 may be provided therein with other numbers of terminal devices 120, which is not limited in the embodiments of the present application.

In an implementation, the communication system 100 may further includes other network entities such as a mobility management entity (MME), an access and mobility management function (AMF), which is not limited in the embodiments of the present application.

A network device may include an access network device and a core network device. That is, a wireless communication system further includes multiple core networks for communicating with the access network device. The access network device may be a long-term evolution (LTE) system, a next-generation mobile communication (next radio, NR) system, or an evolutional base station (evolutional node B, which can be abbreviated as eNB or e-NodeB) an authorized auxiliary access long-term evolution (LAA-LTE) system, a macro base station, a micro base station (also called small base station), a pico base station, an access point (AP), a transmission point (TP) or a new generation Node B (gNodeB).

It should be understood that a device with communication functions in the network/system in the embodiments of the present application may be referred to as a communication device. Taking the communication system shown in FIG. 1 as an example, the communication device may include a network device and a terminal device with communication functions. The network device and the terminal device may be the exemplary devices as described above, which will not be repeated here. The communication device may further include other devices in the communication system, such as a network controller, a mobility management entity, and other network entities, which are not limited in the embodiments of the present application.

It should be understood that the terms “system” and “network” are often used interchangeably herein. The term “and/or” herein is only an association relationship to describe associated objects, which indicates that there may be three kinds of relationships. For example, “A and/or B” may represent: A exists alone, both A and B exist, and B exists alone. In addition, a character “/” herein generally indicates that related objects before and after this character are in an “or” relationship.

It should be understood that, “indicate” mentioned in the embodiments of the present application may mean a direct indication or an indirect indication, or represent that there is an association relationship. For example, A indicating B may mean that A directly indicates B, for example, B may be obtained through A; alternatively, A indicating B may mean that A indirectly indicates B, for example, A indicates C, and B may be obtained through C; alternatively, A indicating B may mean that there is an association relationship between A and B.

In the description of the embodiments of the present application, the term “correspond” may mean that there is a directly correspondence or an indirectly correspondence between the two, or may mean that there is an association between the two, or may mean a relationship of indicating and being indicated, or configuring and being configured, or the like.

To facilitate understanding of the technical solutions of the embodiments of the present application, the relevant technologies of the embodiments of the present application are described below. The following relevant technologies, as optional solutions, may be arbitrarily combined with the technical solutions of the embodiments of the present application, and those combined solutions all belong to the protection scope of the embodiments of the present application.

As shown in FIG. 2, a zero power consumption device mainly combines radio frequency power harvesting technology, backscattering technology, low power consumption computing technology to achieve an advantage of a device node that do not carry a power supply. Power harvesting of zero power consumption devices may also be called radio frequency power collecting, which mainly converts radio frequency power into direct current. Power can be stored in batteries or capacitors, or it may be used directly to drive logic circuits, digital chips or sensor devices after collected, to complete functions and applications, such as modulation and transmission of a backscattering signal, collection and processing of sensor information.

With development of the 5G system, a requirement that the 5G system support a zero power consumption device access to a network appears in 3GPP standards. Scenarios mainly contraposed have following characteristics: extreme environment, which is not suitable for common terminals work; terminals that use very low power consumption and cost; battery-free terminals, or the like. For example, a zero power consumption communication system may be used in a wireless industrial inductive network, smart agriculture, smart warehousing and logistics, smart home or other scenarios.

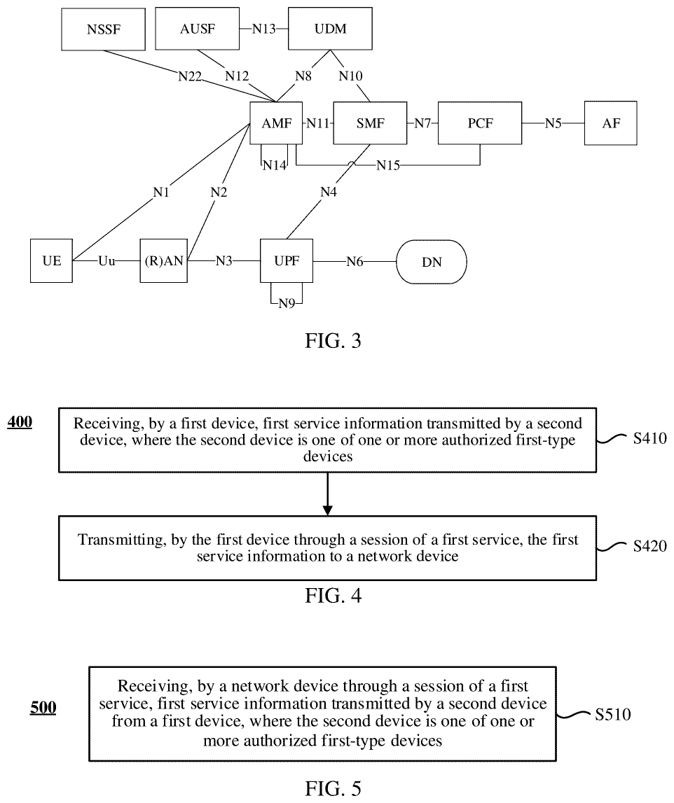

FIG. 3 exemplarily shows a 5G network system architecture. In a 5G core network (5GC), each node can be called a network function (NF), where a name and function of each NF includes: a network slice selection function (NSSF) which is mainly used to manage network slicing related information, such as selecting a network slice for a terminal device; an authentication server function (AUSF) which is used to complete an identity authentication function of user access; unified data management (UDM) which is used to manage and store subscription data and authentication data; an access and mobility management function (AMF) which is used to complete mobility management, security anchor point and security context management, or the like; a session management function (SMF) which is used to complete session management, UE IP address allocation and management, or the like; a policy control function (PCF) which is used to support a unified policy framework and provide policy rules; an application function (APP Function, AF) which is used for external application servers; a user plane function (UPF) which is used for complex user plane processing, such as forwarding traffic between a wireless access network and the Internet, reporting traffic usage, implementing policy of quality of service (QOS), or the like; or a data network (DN), i.e., a 5GC external data network (e.g., the Internet).

In addition, data is transmitted through corresponding interfaces between various nodes of the 5GC (5G core network), between user equipment (UE) and the nodes of the 5G core network, between the UE and a radio access network (RAN), and between the RAN and the nodes of the 5G core network. For example, as shown in FIG. 3, in the 5GC, the AMF transmits data with the NSSF via interface N22; the AMF transmits data with the SMF via interface N11; the AMF transmits data with the AUSF via N12; the AMF transmits data with the UDM via interface N8; the SMF transmits data with the UPF via interface N4, the UPF transmits data with the RAN via interface N3, the UPF transmits data with the data network via interface N6, or the like. The UE transmits data with the AMF via interface N1; The UE transmits data with the RAN via interface Uu; the RAN transmits data with the AMF via interface N2, and the RAN transmits data with the UPF via interface N3. It should be understood that, only part of the interfaces between nodes are described here, and other interfaces between other nodes of the 5GC in FIG. 3 will not be described in detail.

Based on power sources and usage manners of the zero power consumption devices, the zero power consumption devices may be classified into the following types.

### 1. Passive Zero Power Consumption Device

The zero power consumption device does not need a built-in battery. When the zero power consumption device approaches a network device (e.g., a reader-writer in an RFID system), the zero power consumption device is within a near field range formed by a radiation of an antenna of the network device. Therefore, the antenna of the zero power consumption device generates an induced current through electromagnetic induction and the induced current drives a low power consumption chip circuit of the zero power consumption device, so as to implement demodulation of a signal on a forward link and modulation of a signal on a backward link and other operations. For a backscattering link, the zero power consumption device transmits a signal by means of backscattering.

It can be seen that the passive zero power consumption device does not need a built-in battery to drive either a forward link or a backward link, so that the passive zero power consumption device is a true zero power consumption device.

The passive zero power consumption device does not need a battery, and a radio frequency circuit and baseband circuit are very simple, for example, do not need a low-noise amplifier (LNA), a power amplifier (PA), a crystal oscillator, an analog-to-digital converter (ADC) and other devices. Therefore, the passive zero power consumption device has many advantages, such as small size, light weight, low price, and long service life.

Characteristics of this type of terminal devices may further include: 1) no battery; 2) acquiring power from surrounding environment, such as radio waves, solar energy, wind energy, mechanical kinetic energy, or the like; 3) no USIM card. This type of terminal devices may further store a certain amount of energy through the surrounding environment, but the energy is generally very less, so supported functional logic is much less than that of common mobile phone terminals.

### 2. Semi-Passive Zero Power Consumption Device

The semi-passive zero power consumption device itself does not have a conventional battery installed, and may harvest radio wave power by using an RF power harvesting module and store harvested power in a power storage unit (e.g., a capacitor). After obtaining the power, the power storage unit may drive a low-power consumption chip circuit of the zero power consumption device to implement demodulation of a signal on a forward link, modulation of a signal on a backward link and other operations. For a backscattering link, the zero power consumption device transmits signals by means of backscattering.

It can be seen that the semi-passive zero power consumption device does not need a built-in battery to drive either a forward link or a backward link. Although the power stored in the capacitor will be used in operation, the power comes from the radio power harvested by the power harvesting module. Therefore, the semi-passive zero power consumption device is also a true zero power consumption device.

The semi-passive zero power consumption devices inherit many advantages of the passive zero power consumption device, so that the semi-passive zero power consumption devices have many advantages, such as small size, light weight, low price and long service life.

### 3. Active Zero Power Consumption Device

The zero power consumption device used in some scenarios may be an active zero power consumption device, and such a device may have a built-in battery. The battery is configured to drive a low power consumption chip circuit of the zero power consumption device to implement operations such as demodulation of a signal on a forward link signal and modulation of a signal on a backward link. However, for a backscattering link, the zero power consumption device transmits signals by means of backscattering. Therefore, zero power consumption of this type of devices is mainly reflected in the fact that the signal transmission on the reverse link does not need the terminal's own power, but uses a backscattering manner.

A battery is built in the active zero power consumption device supply power to a RFID chip, to increase a reading and writing distance of a tag, and improve reliability of communication. Therefore, it can be applied in some scenarios with relatively high requirements on communication distance and reading delay.

Considering the characteristic of extremely low complexity of the zero power consumption device, such as the passive zero power consumption device, it may not be able to support a complex protocol stack and a complex communication process. Therefore, how to better adapt the characteristics of the zero power consumption device, such as the passive zero power consumption device, to enable the zero power consumption device to communicate with the network has becomes a problem to be solved.

In the embodiments, a communication method is provided, which includes:
receiving, by a first device, first service information transmitted by a second device, where the second device is one of one or more authorized first-type devices; and
transmitting, by the first device through a session of a first service, the first service information to a network device.

In some embodiments, the method further includes:
transmitting, by the first device, first information, where the first information includes identities of one or more first-type devices; and
receiving, by the first device, second information, where the second information includes identities of the one or more authorized first-type devices.

In some embodiments, the method further includes:
transmitting, by the first device, a trigger signal;
receiving, by the first device, one or more response information of the trigger signal;
determining, by the first device based on the one or more response information, identities of the one or more first-type devices; and
generating, by the first device based on the identities of the one or more first-type devices, the first information.

In some embodiments, the trigger signal includes a first target layer 2 (L2) identity.

In some embodiments, the trigger signal further includes trigger related information; where the trigger related information includes at least one of: an identity of the first device, trigger content related information, or indication information used by the first device for relay transmission.

In some embodiments, the trigger content related information includes at least one of: an identity of the first service, an identity of a service group to which the first service belongs, a target password, or an information type to be detected in the first service.

In some embodiments, at least one of the identity of the service group to which the first service belongs or the information type to be detected in the first service is preconfigured, or is configured by a network device.

In some embodiments, the first target L2 identity is located in a packet header of a MAC layer in a protocol stack of a PC5 interface.

In some embodiments, the trigger signal further includes a first source L2 identity; where the first source L2 identity is located in the packet header of the MAC layer in the protocol stack of the PC5 interface.

In some embodiments, the trigger related information is contained in a signaling layer in a protocol stack of a PC5 interface, and the signaling layer is located upper than a MAC layer in the protocol stack of the PC5 interface.

In some embodiments, the trigger signal is a signal of a physical layer in the protocol stack of the PC5 interface.

In some embodiments, the method further includes:
determining, by the first device based on identity related information corresponding to the first service and a first address mapping relationship, the first target layer 2 (L2) identity, where the first address mapping relationship is preconfigured, or is configured by a network device.

In some embodiments, the method further includes:
determining, by the first device based on a service area of the first service, the identity related information corresponding to the first service in a case where the first device is located in the service area of the first service, where the service area of the first service is preconfigured, or is configured by the network device.

In some embodiments, the method further includes:
determining, by the first device based on identity related information corresponding to the first service and a password mapping relationship, the target password, where the password mapping relationship is preconfigured, or is configured by a network device.

In some embodiments, the first address mapping relationship includes: a mapping relationship between an L2 identity and each identity related information in one or more identity related information configured for the first device.

In some embodiments, the password mapping relationship includes a mapping relationship between a password and each identity related information in one or more identity related information corresponding to the first device.

In some embodiments, the identity related information includes one of: an identity of a service, an identity of a service group, or an identity of a first-type device.

In some embodiments, transmitting, by the first device, the trigger signal includes:
transmitting, by the first device, the trigger signal in a case where the first device determines that itself is used for relay transmission based on authorization information, where the authorization information is preconfigured, or is configured by a network device.

In some embodiments, the authorization information includes an indication of whether the first device is used for relay transmission.

In some embodiments, the authorization information includes an identity of a service of relay transmission.

In some embodiments, generating the first information based on the identities of the one or more first-type devices includes:
generating, by the first device based on the identities of the one or more first-type devices and third information, the first information.

In some embodiments, the third information includes at least one of: information collected by the one or more first-type devices, an identity of the first service, or indication information of completing identity verification.

In some embodiments, the method further includes:
transmitting, by the first device, a session establishment request after the first device receives the second information, where the session establishment request is used to request establishment of the session of the first service.

In some embodiments, the session establishment request is carried by an uplink NAS transmission message.

In some embodiments, the uplink NAS transmission message further carries a parameter of the first service;
where the parameter of the first service include at least one of: a data network name (DNN) corresponding to the first service, single network slice selection assistance information (S-NSSAI) corresponding to the first service, or indication information of a session of a zero power consumption service.

In some embodiments, the session of the first service is a protocol data unit (PDU) session of the first service.

In some embodiments, the first service is a zero power consumption service; and/or, a first-type device is a zero power consumption device.

In the embodiments, a communication method is further provided, which includes:
receiving, by a network device through a session of a first service, first service information transmitted by a second device from a first device, where the second device is one of one or more authorized first-type devices.

In some embodiments, the method further includes:
receiving, by the network device, first information transmitted by the first device, where the first information includes identities of one or more first-type devices; and
determining, by the network device based on the first information, the one or more authorized first-type devices;
generating, by the network device based on identities of the one or more authorized first-type devices, second information; and
transmitting, by the network device, second information to the first device.

In some embodiments, determining, by the network device based on the first information, the one or more authorized first-type devices includes:
determining, by the network device based on the first information, the one or more authorized first-type devices in a case where the network device determines that the first device is used for relay transmission based on authorization information corresponding to the first device, where the authorization information corresponding to the first device includes an indication of whether the first device is used for relay transmission.

In some embodiments, determining, by the network device based on the first information, the one or more authorized first-type devices includes:
determining, by the network device based on preconfiguration information, the one or more authorized first-type devices from the one or more first-type devices included in the first information.

In some embodiments, the preconfiguration information includes at least one of:
identities of one or more first-type devices which are allowed to be authorized;
identities of the one or more first-type devices which are allowed to be authorized under each service in one or more services; or
an information type to be detected under each service in the one or more services.

In some embodiments, the session of the first service is a packet data unit (PDU) session of the first service.

In some embodiments, the first service is a zero power consumption service; and/or, a first-type device is a zero power consumption device.

In the embodiments, a communication method is further provided, which includes:
transmitting, by a second device, first service information to a first device, where the first service information is transmitted by the first device to a network device through a session of a first service, and the second device is one of one or more authorized first-type devices. In some embodiments, the method further includes:

receiving, by the second device, a trigger signal transmitted by the first device; and
transmitting, by the second device, response information of the trigger signal to the first
device, where the response information includes an identity of the second device.

In some embodiments, the trigger signal includes a first target L2 identity.

In some embodiments, the trigger signal further includes trigger related information; where
the trigger related information includes at least one of: an identity of the first device, trigger content related information, or indication information used by the first device for relay transmission.

In some embodiments, the trigger content related information includes at least one of: an identity of the first service, an identity of a service group to which the first service belongs, a target password, or an information type to be detected in the first service.

In some embodiments, the first target L2 identity is located in a packet header of a MAC layer in a protocol stack of a PC5 interface.

In some embodiments, the trigger signal further includes a first source L2 identity, where the first source L2 identity is located in a packet header of a MAC layer in a protocol stack of a PC5 interface.

In some embodiments, the trigger related information is contained in a signaling layer in a protocol stack of a PC5 interface, and the signaling layer is located upper than a MAC layer in the protocol stack of the PC5 interface.

In some embodiments, the trigger signal is a signal of a physical layer in a protocol stack of a PC5 interface.

In some embodiments, transmitting, by the second device, the response information of the trigger signal to the first device, includes:
transmitting, by the second device, the response information of the trigger signal to the first device in a case where the second device determines that a preset condition is met based on the trigger signal.

In some embodiments, the preset condition includes at least one of:
identity related information corresponding to the first service matching preconfigured service related information, where the identity related information corresponding to the first service is determined based on a first target L2 identity in the trigger signal and a second address mapping relationship; or
trigger related information in the trigger signal matching the preconfigured service related information.

In some embodiments, the second address mapping relationship includes: a mapping relationship between an L2 identity and each identity related information in one or more identity related information configured for the second device.

In some embodiments, the identity related information includes one of: an identity of a service, an identity of a service group, or an identity of a first-type device.

In some embodiments, the preconfigured service related information includes at least one of: an identity of a service supported by the second device, an identity of a service group to which the service supported by the second device belongs, an identity of the second device, a verification password used by the second device, or an information type supported by the second device.

In some embodiments, the response information further includes a second target L2 identity; where the second target L2 identity is the first target L2 identity in the trigger signal, or the first source L2 identity in the trigger signal.

In some embodiments, the response information further includes information collected by the second device.

In some embodiments, the first service is a zero power consumption service; and/or, a first-type device is a zero power consumption device.

FIG. 4 is a schematic flowchart of a communication method 400 according to an embodiment of the present application. The method may optionally be applied to the system shown in FIG. 1, but is not limited thereto. The method includes at least part of the following:
S410, receiving, by a first device, first service information transmitted by a second device, where the second device is one of one or more authorized first-type devices;
S420, transmitting, by the first device through a session of a first service, the first service information to a network device.

FIG. 5 is a schematic flowchart of a communication method 500 according to an embodiment of the present application. The method may optionally be applied to the system shown in FIG. 1, but is not limited thereto. The method includes at least part of the following:
S510, receiving, by a network device through a session of a first service, first service information transmitted by a second device from a first device, where the second device is one of one or more authorized first-type devices.

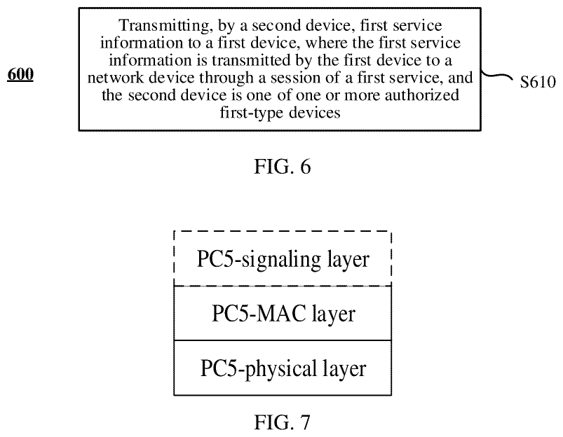

FIG. 6 is a schematic flowchart of a communication method 600 according to an embodiment of the present application. The method may optionally be applied to the system shown in FIG. 1, but is not limited thereto. The method includes at least part of the following:
S610, transmitting, by a second device, first service information to a first device, where the first service information is transmitted by the first device to a network device through a session of a first service, and the second device is one of one or more authorized first-type devices.

In an implementation, the first device is a terminal device, for example, it may be customer premise(s) equipment (CPE), a smart phone, and all possible terminal types are not exhaustive here.

A first-type device is a zero power consumption device, such as the above-mentioned passive zero power consumption device, semi-passive zero power consumption device, or active zero power consumption device. The one or more authorized first-type devices may refer to one or more authorized zero power consumption devices. The second device may be any one of the one or more authorized first-type devices.

The first service is any one of one or more services. The any one of the one or more services may refer to a zero power consumption service, that is, the first service may be any one of one or more zero power consumption services.

The first service information may refer to information of the first service collected by the second device. The session of the first service may be a protocol data unit (PDU) session of the first service.

The network device may be a first network device, and the first network device may be a first core network device. The first core network device may be one of one or more NFs in a core network. The one or more NFs in the core network are the same as those shown in FIG. 3 above, which will not be repeated here. For example, the first core network device may be any PCF or AF in the one or more NF, which is not exhaustive here.

First configuration information may be pre-stored in the first device, and the first configuration information includes at least one of following information: authorization information, related configuration information corresponding to a service of relay transmission, a first address mapping relationship, or a password mapping relationship.

The first configuration information is preconfigured in the first device, for example, it can be pre-stored in the first device before (or after) the first device is produced from the factory. Alternatively, the first configuration information is configured by a network device, where the network device may be a second network device. The second network device may be the same or different from the first network device, for example, the second network device may be a second core network device, such as a PCF, an AF; or the second network device may also be an access network device, which is not limited in the present embodiments.

The authorization information includes an indication of whether the first device is used for relay transmission. And/or, the authorization information may further includes an identity of a service on which the first device is able to perform relay transmission.

The indication of whether the first device is used for relay transmission refers to an indication of whether a first-type device can be used for relay transmission of service information of zero power consumption communication. For example, if the indication of whether the first device is used for relay transmission is 1, it means that the first device is authorized for relay transmission; if the indication of whether the first device is used for relay transmission is 0, it means that the first device is not authorized for relay transmission. It should be understood that the above manner is only an exemplary illustration, and does not mean that the indication of whether the first device is used for relay transmission may only be in the above manner, which is not exhaustive in the present embodiments.

The number of services on which the first device is able to perform relay transmission may be one or more, that is, the authorization information may include an identity of each of the one or more services on which the first device is able to perform relay transmission.

Exemplarily, in a case where the authorization information may only include the indication of whether the first device is used for relay transmission, if the indication of whether the first device is used for relay transmission indicates that the first device is used for relay transmission, the first device may performs relay transmission on all service information of the zero power consumption communication; if the indication of whether the first device is used for relay transmission indicates that the first device is not used for relay transmission, the first device does not perform relay transmission and does not perform other subsequent processing.

Exemplarily, the authorization information may only include the identity of the service on which the first device is able to perform relay transmission. In this case, as long as the identity of the service on which the first device is able to perform relay transmission contained in the authorization information is not zero, it is defaulted that the first device can be used for relay transmission, and it is further determined that one or more services on which the first device is able to performs relay transmission.

Exemplarily, the authorization information may include the indication of whether the first device is used for relay transmission, and in a case where the indication of whether the first device is used for relay transmission indicates that the first device is used for relay transmission, the authorization information may further include: identities (IDs) of the one or more services on which the first device is able to perform relay transmission.

The related configuration information corresponding to the service of relay transmission may include at least one of: a service area of the service of relay transmission, an identity of a first-type device corresponding to the service of relay transmission, an identity of a service group to which the service of relay transmission belongs, an information type to be detected in the service of relay transmission, or a session parameter corresponding to the service of relay transmission.

As mentioned above, the number of services on which the first device is able to perform relay transmission may be one or more, the related configuration information corresponding to the service of relay transmission refers to related configuration information corresponding to each service of relay transmission in one or more services of relay transmission.

The service area of the services of relay transmission may be represented by a cell identity or a geographical location, which is not limited here. It should be understood that different services of relay transmission correspond to different service areas.

The identity of the first-type device corresponding to the service of relay transmission may refer to identities of one or more first-type devices that are able to perform relay transmission corresponding to the service on which the first device is able to perform relay transmission. For example, the service on which the first device is able to perform relay transmission is service 1, and there are 10 first-type devices corresponding to service 1, the first-type devices on which the first device is able to perform relay transmission may be all 10 first-type devices, or may be only part of them, such as 5 first-type devices of them. In the present embodiments, the identities of first-type devices that are able to perform relay transmission under the service on which the first device is able to perform relay transmission may be preconfigured. It should be understood that identities of different services of relay transmission are different, and first-type devices corresponding to the different services of the relay transmission are also different. For example, related configuration corresponding to service 1 of relay transmission may include: identity 001 of service 1, identity b1 of a first-type device corresponding to service 1 and identity b2 of a first-type device corresponding to service 1, etc.; related configuration corresponding to service 2 of relay transmission may include: identity 010 of service 2 and identity b3 of a first-type device corresponding to service 2.

The identity of the service group to which the service of relay transmission belongs may be that different services of relay transmission have the same identity of the service group, or may be that different services of relay transmission have different identities of service groups; however, identities of services of relay transmission corresponding to different identities of service groups are different. For example, related configuration corresponding to service 1 of relay transmitted may include: correspondence between identity 001 of service 1 and identity a1 of a service group to which service 1 belongs; related configuration corresponding to service 2 may include: correspondence between identity 010 of service 2 and identity a1 of a service group to which service 2 belongs; related configuration corresponding to service 3 may include: correspondence between identity 011 of service 3 and identity a2 of a service group to which service 3 belongs.

The information type to be detected in the service of relay transmission may include: at least one of temperature data, humidity data, time data, or the like, and all possible information types are not exhaustive here.

The session parameter corresponding to the services of relay transmission may be a PDU session parameter corresponding to the service of relay transmission. For example, the PDU session parameter corresponding to the service of relay transmission may include at least one of: a data network name (DNN) corresponding to the service of relay transmission, or a single-network slice selection assistance information (S-NSSAI) corresponding to the service of relay transmission.

The first address mapping relationship may include: a mapping relationship between an layer 2 (L2) identity and each identity related information in one or more identity related information configured for the first device. It should be understood that different identity related information corresponds to different L2 identities.

The identity related information includes one of: an identity of a service, an identity of a service group, or an identity of a first-type device. The one or more identity related information includes at least one of: an identity of a service, an identity of a service group, or an identity of a first-type device.

In some embodiments, the first address mapping relationship may include at least one of:
a mapping relationship between an L2 identity and an identity of each service in identities of one or more services configured for the first device; where identities of different services correspond to different L2 identities;
a mapping relationship between an L2 identity and an identity of each service group in identities of one or more service groups configured for the first device; where identities of different service groups correspond to different L2 identities, and the identities of different service groups correspond to identities of different services, and any one service group contains one or more services; or
a mapping relationship between an L2 identity and an identity of each first-type device in identities of one or more first-type device configured for the first device; where identities of different first-type devices correspond to different L2 identities.

The first address mapping relationship may be set to any one, any two, or all of them according to actual conditions. In an example, the first address mapping relationship may include at least the mapping relationship between the L2 identity and the identity of each service in the identities of the one or more services configured for the first device.

The password mapping relationship may include: a mapping relationship between a password and each identity related information in one or more identity related information corresponding to the first device. The definition of the identity related information is the same as that in the above embodiments, which will not be repeated here. It should be understood that different identity related information corresponds to different passwords.

The password mapping relationship may include at least one of:
a mapping relationship between a password and an identity of each service in identities of one or more services configured for the first device; where identities of different services correspond to different passwords;
a mapping relationship between a password and identity of each service group in identities of one or more service groups configured for the first device; where identities of different service group correspond to different passwords, different service groups includes different services, and any one service group includes one or more services; or
a mapping relationship between a password and an identity of each first-type device in identities of one or more first-type devices configured for the first device; where identities of different first-type devices correspond to different passwords.

Second configuration information may be pre-stored in the second device, where the second configuration information may include at least a second address mapping relationship.

The second address mapping relationship includes: a mapping relationship between an L2 identity and each identity related information in one or more identity related information corresponding to the second device. The contents in which the identity related information may include are similar to that in the above embodiments, which will not be repeated here.

In some embodiments, the second address mapping relationship may include at least one of:
a mapping relationship between an L2 identity and an identity of each service in identities of one or more services configured for the second device; where identities of different services correspond to different L2 identities;
a mapping relationship between an L2 identity and an identity of each service group in the identities of one or more service groups configured for the second device; where identities of different service groups correspond to different L2 identities, and the identities of different service groups correspond to identities of different services, and any one service group contains one or more services; or
a mapping relationship between an L2 identity and an identity of each first-type device in identities of one or more first-type devices configured for the second device; where identities of different first-type devices correspond to different L2 identities.

In an example, the second address mapping relationship can be identical to the first address mapping relationship. That is to say, the one or more identity related information corresponding to the first device is exactly the same as the one or more identity related information corresponding to the second device.

In another example, the second address mapping relationship may be a subset of the first address mapping relationship. That is to say, the one or more identity related information configured for the second device may be a subset of the one or more identity related information configured for the first device. For example, the one or more identity related information configured for the second device may only include identities of one or more services, and the one or more identity related information configured for the first device may include: identities of one or more services, identities of one or more first-type devices, or the like.

The second configuration information may further include preconfigured service related information; where the preconfigured service related information may include at least one of: an identity of the second device, an identity of a service supported by the second device, a verification password used by the second device, an information type supported by the second device, or an identity of the service group to which the service supported by the second device belongs.

The identity of the service supported by the second device may be one or more, which is not limited in the present embodiments. The verification password used by the second device may be preset according to actual conditions, which is not limited in the present embodiments. The information type supported by the second device may be at least one of temperature data, humidity data, time data, or the like, and all possible information types are not exhaustive here. The identity of the service group to which the service supported by the second device belongs may also be set according to actual conditions, which is not limited in the present embodiments.

It should be understood that the second device preconfiguring the second configuration information may be written into a memory of the second device before produced from the factory, or may be written into the memory of the second device according to actual requirements after produced from the factory. All possible writing methods or timings are not limited here.

It should be noted that the second device may be any one of one or more authorized first-type devices, the information may be stored in each authorized first-type device, but will not be repeated in detail.

The third configuration information may be stored on a network device side, and the third configuration information may include at least the authorization information of the first device. In addition, the third configuration information may further include preconfiguration information, and the preconfiguration information includes at least one of: identities of one or more first-type devices which are allowed to be authorized; identities of the one or more first-type devices which are allowed to be authorized under each service in one or more services; or an information type to be detected under each service in the one or more services. Here, the network device storing the third configuration information may be a third network device, which may be the same or different from the first network device, and the third network device may be the same or different from the second network device. Exemplarily, the third network device may be a third core network device, such as a PCF, an AF, which is not limited in the present embodiments.

In an implementation, on a side of the first device, before performing S410, the method may include: transmitting, by the first device, a trigger signal; receiving, by the first device, one or more response information of the trigger signal; determining, by the first device based on the one or more response information, identities of the one or more first-type devices; and generating, by the first device based on the identities of the one or more first-type devices, the first information. Correspondingly, on a side of the second device, before performing S610, the method may include: receiving, by the second device, a trigger signal transmitted by the first device; and transmitting, by the second device, response information of the trigger signal to the first device, where the response information includes an identity of the second device.

It should be noted that the second device may be any one of one or more authorized first-type devices on the side of the first device, so each first-type device may perform the same processing as the second device, which will not be repeated in detail.

Optionally, transmitting, by the first device, the trigger signal may include: transmitting, by the first device, the trigger signal in a case where the first device determines that itself is used for relay transmission based on authorization information, where the authorization information is preconfigured, or is configured by a network device. In addition, the method may also include: skipping, by the first device, transmission of the trigger signal in a case where the first device determines that itself is not used for relay transmission based on the authorization information, and ending the processing.

For example, in a case where the authorization information only includes an indication of whether the first device is used for relay transmission, and the indication of whether the first device is used for relay transmission indicates that the first device is not used for relay transmission, the first device determines that itself is not used for relay transmission, and the first device does not transmit the trigger signal. For example, in a case where the authorization information only includes the indication of whether the first device is used for relay transmission, the indication of whether the first device is used for relay transmission indicates that the first device is used for relay transmission, the first device determines that itself is used for relay transmission, and the first device transmits the trigger signal. For another example, if the authorization information only includes identities (IDs) of one or more services on which the first device is able to perform relay transmission, the first device determines that itself is used for relay transmission, and the first device transmits the trigger signal. For yet another example, the authorization information includes the indication of whether the first device is used for relay transmission, and the indication of whether the first device is used for relay transmission indicates that the first device is used for relay transmission, and the authorization information includes the identities (IDs) of the one or more services on which the first device is able to perform relay transmission, the first device determines that itself is used for relay transmission, and the first device transmits the trigger signal.

In an implementation, the trigger signal may include: a first target layer 2 (L2) identity. In addition, the trigger signal further includes: a first source L2 identity.

The first source L2 identity may be allocated by the first device itself, and the specific allocation manners is not limited in the present embodiment.

The trigger signal may be a signal of a physical layer, and the trigger signal may only include the first target L2 identity and first source L2 identity.

In some embodiments, the trigger signal is a signal of a physical layer in the protocol stack of a PC5 interface. As shown in FIG. 7, the protocol stack of the PC5 interface may include three layers, which may be respectively represented as: PC5-signaling layer (or referred to as a signaling layer in the protocol stack of the PC5 interface), PC5-MAC layer (or referred to as a MAC layer in the protocol stack of the PC5 interface), and PC5-physical layer (or referred to as a physical layer in the protocol stack of the PC5 interface).

The first target L2 identity in the trigger signal is located in a packet header of the MAC layer in the protocol stack of the PC5 interface. The first source L2 identity may also be located in the packet header of the MAC layer in the protocol stack of the PC5 interface.

In an implementation, the manner in which the first device determines the first target L2 identity in the trigger signal may include: determining, by the first device based on identity related information corresponding to the first service and an address mapping relationship, the first target layer 2 (L2) identity, where the address mapping relationship is preconfigured, or is configured by a network device.

As mentioned above, the identity related information may include one of: an identity of a service, an identity of a service group, or an identity of a first-type device; correspondingly, the identity related information corresponding to the first service may include one of: an identity of a service corresponding to the first service, an identity of a service group corresponding to the first service, an identity of first-type devices corresponding to the first service. It should be understood that the identity of the service group corresponding to the first service may refer to an identity of a service group to which the first service belongs; the identity of the first-type devices corresponding to the first service may refer to an identity of the first-type device in which the first device needs to detect or on which the first device is able to perform relay transmission under the first service.

Determining, by the first device based on the identity related information corresponding to the first service and the address mapping relationship, the first target L2 identity, may be any one of:
determining, based on the identity of the service corresponding to the first service, an identity of a matching service from the address mapping relationship, and taking an L2 identity corresponding to the identity of the matching service as the first target L2 identity;
determining, based on the identity of the service group corresponding to the first service, an identity of a matching service group from the address mapping relationship, and taking an L2 identity corresponding to the identity of the matching service group as the first target L2 identity; or
determining, based on the identity of the first-type devices corresponding to the first service, an identity of a matching first-type device from the address mapping relationship, and taking an L2 identity corresponding to the identity of the matching first-type device as the first target L2 identity.

It should be noted that in a case where the identity related information corresponding to the first service is the identity of the first-type device corresponding to the first service, if the first service corresponds to identities of one or more first-type devices, one or more first target L2 identities may be determined based on the identities of the one or more first-type devices and the address mapping relationship; accordingly, one or more trigger signals may be generated, where different trigger signals use different first target L2 identities. However, in this case, different trigger signals may use the same source L2 identity. Since the source L2 identity is uniformly generated by the first device itself, the same source L2 identity may be used.

Optionally, the first device may generate and transmit the trigger signal in a case where a transmitting period is reached. Accordingly, in a case where it is determined based on the current time and the transmitting period that a trigger signal needs to be transmitted, the first device may determine the first target L2 identity based on the identity related information corresponding to the first service and the address mapping relationship.

A period duration of the transmitting period may set according to actual conditions, for example, the period duration may be set to 1 hour, 12 hours, or longer or shorter, which is not exhaustive here.

It should be understood that, in this example, the manner in which the first device determines the first service may be preconfigured according to actual conditions. For example, the first device may determine that there are three services can be transmitted via relay based on authorization information, and the user or administrator may pre-allocate any one of them as the first service.

The processing method for determining, by the first device based on the identity related information corresponding to the first service and the address mapping relationship, the first target L2 identity is the same as that in the above embodiments, which will not be repeated here.

Optionally, the first device may generate the trigger signal according to an operation instruction of the user. Accordingly, the first device may determine the identity related information corresponding to the first service based on the operation instruction of the user, and determine the first target L2 identity based on the identity related information corresponding to the first service and the address mapping relationship.

In some embodiments, the operation instruction of the user may be generated by a user's operation on an interactive interface of the first device. For example, the first service of this selection may be determined based on the user's operating instruction, and a service identity of the first service may be used as the identity related information corresponding to the first service; for another example, one or more first-type devices under the first service of this selection may be determined based on the user's operating instruction, and identities of the one or more first-type devices under the first service of this selection may be used as the identity related information corresponding to the first service.

The processing method for determining, by the first device based on the identity related information corresponding to the first service and the address mapping relationship, the first target L2 identity is the same as that in the above embodiments, which will not be repeated here.

Optionally, the first device may determine whether it is currently located in a service area of the first service current according to its current location, and generate the trigger signal if it is determined that the current location is in the service area of the first service. Correspondingly, in a case where the first device is located in the service area of the first service, the first device determines the identity related information corresponding to the first service based on the service area of the first service, where the service area of the first service is preconfigured, or is configured by the network device. Furthermore, the first device determines the first target L2 identity based on the identity related information corresponding to the first service and the address mapping relationship.

The above-mentioned embodiments have illustrated that the first device may pre-store related configuration information corresponding to the service of relay transmission. Because the first service is any one of one or more services on which the first device is able to perform relay transmission, correspondingly, the first device may determines whether the first device is currently located in a service area of any service based on the current location and related configuration information corresponding to the service of relay transmission. If it is located in the service area of any service, the service is used as the first service, that is, it is determined that the first device is located in the service area of the first service.

Furthermore, in a case where the first device determines that it is located in the service area of the first service, the first device may further determine at least one of an identity of a service corresponding to the first service, an identity of a service group corresponding to the first service, or an identity of a first-type device corresponding to the first service based on related configuration information corresponding to the first service. The first device may take any one of the identity of the service corresponding to the first service, the identity of the service group corresponding to the first service, and the identity of the first-type device corresponding to the first service as the identity related information corresponding to the first service.

The processing method for determining, by the first device based on the identity related information corresponding to the first service and the address mapping relationship, the first target L2 identity is the same as that in the above embodiments, which will not be repeated here.

In an implementation, in addition to the first target L2 identity and the first source L2 identity, the trigger signal further includes trigger related information; where the trigger related information includes at least one of: an identity of the first device, trigger content related information, or indication information used by the first device for relay transmission.

The trigger content related information includes at least one of: an identity of the first service, an identity of a service group to which the first service belongs, a target password, or an information type to be detected in the first service.

The first target L2 identity and the first source L2 identity in the trigger signal may also be located in a packet header of a MAC layer in a protocol stack of a PC5 interface. The trigger related information is contained in a signaling layer in the protocol stack of the PC5 interface, and the signaling layer is located upper than a MAC layer in the protocol stack of the PC5 interface.

At least one of an identity of a service group to which the first service belongs or an information type to be detected in the first service is preconfigured, or is configured by a network device. In some embodiments, at least one of the identity of the service group to which the first service belongs and the information type to be detected in the first service may be contained in the related configuration information corresponding to the above-mentioned service of relay transmission. That is, after the first device determines the first service, it may obtain at least one of the identity of the service group to which the first service belongs and the information type to be detected in the first service from the related configuration information corresponding to the above-mentioned service of relay transmission based on the identity of the service corresponding to the first service.

The indication information used by the first device for relay transmission may be represented by a preset indication value or preset indication content. For example, in a case where an indication value of the indication information used by the first device for relay transmission is 01, it indicates that the first device is able to be used for relay transmission; otherwise, it indicates that the first device is unable to be used for relay transmission. It should be understood that this is only an illustrative description and is not intended to limit the present embodiments.

In an implementation, the target password may be determined based on the above-mentioned password mapping relationship. The method for determining the target password may include: determining, by the first device based on identity related information corresponding to the first service and the password mapping relationship, the target password, where the password mapping relationship is preconfigured, or is configured by a network device.

As described above, the identity related information corresponding to the first service may include one of: an identity of a service corresponding to the first service, an identity of a service group corresponding to the first service, an identity of a first-type device corresponding to the first service. In some embodiments, the identity of the service group corresponding to the first service may refer to an identity of a service group to which the first service belongs; and the identity of the first-type device corresponding to the first service may refer to an identity of a first-type device in which the first device needs to detect or on which the first device is able to perform relay transmission under the first service.

Determining, by the first device based on the identity related information corresponding to the first service and the password mapping relationship, the target password, may be any one of:
determining, based on the identity of the service corresponding to the first service, an identity of a matching service from the password mapping relationship, and taking a password corresponding to the identity of the matching service as the target password;
determining, based on the identity of the service group corresponding to the first service, an identity of a matching service group from the password mapping relationship, and taking an password corresponding to the identity of the matching service group as the target password; or
determining, based on the identity of the first-type devices corresponding to the first service, an identity of a matching first-type device from the password mapping relationship, and taking the password corresponding to the identity of the matching first-type device as the target password.

It should be noted that in a case where the identity related information corresponding to the first service is the identity of the first-type device corresponding to the first service, if the first service corresponds to identities of one or more first-type devices, one or more target passwords may be determined based on the identities of the one or more first-type devices and the password mapping relationship. Accordingly, one or more trigger signals may be generated, where different trigger signals includes different target passwords.

Based on the above-mentioned processing, the first device may generate the trigger signal, and then transmit the trigger signal. It should be noted that when the first device transmits the trigger signal, a transmission power and/or coverage range of the trigger signal may further be predetermined. For example, the first device may determine the transmission power and/or coverage range according to a size of a service area of the first service.

After the first device transmits a trigger signal, the processing that the second device may perform after receiving the trigger signal includes: receiving, by the second device, a trigger signal transmitted by the first device; and transmitting, by the second device, response information of the trigger signal to the first device, where the response information includes an identity of the second device.

In an implementation, transmitting, by the second device, the response information of the trigger signal to the first device includes: transmitting, by the second device, the response information of the trigger signal to the first device in a case where the second device determines that a preset condition is met based on the trigger signal.

In addition, it may further include: discarding, by the second device, the trigger signal in a case where the second device determines that a preset condition is not met based on the trigger signal, without processing.

The preset condition includes at least one of: identity related information corresponding to the first service matching preconfigured service related information, where the identity related information corresponding to the first service is determined based on a first target L2 identity in the trigger signal and a second address mapping relationship; or
trigger related information in the trigger signal matching the preconfigured service related information.

The preconfigured service related information includes at least one of: an identity of a service supported by the second device, an identity of a service group to which the service supported by the second device belongs, an identity of the second device, a verification password used by the second device, or an information type supported by the second device. The description of the preconfigured service related information has been detailed in the above embodiments, which will not be repeated here.

Optionally, the preset condition includes the identity related information corresponding to the first service matching the preconfigured service related information. The preconfigured service related information includes at least one of: an identity of a service supported by the second device, an identity of a service group to which the service supported by the second device belongs, an identity of the second device.

A processing method for determining, by the second device, whether the identity related information of the first service matches the preconfigured service related information may include: determining, by the second device, the identity related information corresponding to the first service based on the first target L2 identity in the trigger signal and the address mapping relationship; and determining that the preset condition is met in a case where the identity related information corresponding to the first service is the same as the preconfigured service related information.

Determining, by the second device, the identity related information corresponding to the first service based on the first target L2 identity in the trigger signal and address mapping relationship may include: performing, by the second device, matching based on the first target L2 identity in the trigger signal and an L2 identity contained in the address mapping relationship, and taking identity related information corresponding to a matched L2 identity as the identity related information corresponding to the first service. The identity related information corresponding to the first service may be any one of an identity of a service corresponding to the first service, an identity of a service group to which the first service belongs, and an identity of a first-type device corresponding to the first service.

Furthermore, the second device may determines that the preset condition is met in a case where the identity related information corresponding to the first service matches any one of the identity of the service supported by the second device, the identity of the service group to which the service supported by the second device belongs, and the identity of the second device included in the preconfigured service related information; otherwise, it is determined that the preset condition is not met.

Optionally, the preset condition includes that the trigger related information in the trigger signal matches the preconfigured service related information. The preconfigured service related information includes at least one of: an identity of a service supported by the second device, an identity of a service group to which the service supported by the second device belongs, an identity of the second device, a verification password used by the second device, or an information type supported by the second device.

A processing method for determining, by the second device, whether the trigger related information in the trigger signal matches the preconfigured service related information may include at least one of:
in a case where the second device obtains a target password from the trigger related information, performing consistency check between the verification password used by the second device in the preconfigured service related information and the target password, and determining that the preset condition is met in a case where the verification passes;
in a case where the second device obtains an information type to be detected in the first service from the trigger related information, if an information type supported by the second device in the preconfigured service related information is the same as the information type to be detected in the first service, determining that the preset condition is met; or
in a case where the second device obtains an identity of a service group to which the first service belongs from the trigger related information, if an identity of a service group where a service supported by the second device in the preconfigured service related information is the same as the identity of the service group to which the first service belongs, determining that the preset condition is met.

Optionally, the preset condition includes: identity related information corresponding to the first service matching the preconfigured service related information; trigger related information in the trigger signal matching the preconfigured service related information. Correspondingly, the preconfigured service related information includes: an identity of a service supported by the second device, an identity of a service group to which the service supported by the second device is belongs, an identity of the second device, a verification password used by the second device, or an information type supported by the second device.

A processing for determining, by the second device, whether the preset condition is met may include: firstly, determining, by the second device, whether identity related information of the first service matches the preconfigured service related information; in a case where it is determined that the identity related information corresponding to the first service is the same as the preconfigured service related information, further determining whether trigger related information in the trigger signal matches the preconfigured service related information; if it does, the preset condition being met; otherwise, the preset condition being not met. Here, the processing methods for determining whether the identity related information of the first service matches the preconfigured service related information, and determining whether the trigger related information in the trigger signal matches the preconfigured service related information are the same as those in the above-mentioned embodiments, which will not be repeated here.

In an implementation, the response information may further includes: a second target L2 identity; where the second target L2 identity is the first target L2 identity in the trigger signal, or the first source L2 identity in the trigger signal. It should be noted that the response information of the trigger signal may further include a second source L2 identity; where the second source L2 identity may be preconfigured by the second device.

Furthermore, the response information further includes: information collected by the second device. That is to say, in a case where the second device currently has acquired the collected information, the information collected by the second device may be carried in the response information of the trigger signal. For example, the information collected by the second device may be information of the first service collected by the second device.

The response information of the trigger signal may also be a signal of a physical layer in a protocol stack of a PC5 interface. The second target L2 identity and the second source L2 identity may be located in a packet header of a MAC layer in the protocol stack of the PC5 interface. The identity of the second device and the information collected by the second device may be contained in a signaling layer in the protocol stack of the PC5 interface, and the signaling layer is located upper than the MAC layer in the protocol stack of the PC5 interface.

The second device is any one of one or more first-type devices, that is, the first device receives one or more response information of the trigger signal, which may mean that: the first device may receive response information of the trigger signal transmitted by one or more first-type devices.

In an implementation, the first device determines identities of the one or more first-type devices based on the one or more response information; and the first device generates the first information based on the identities of the one or more first-type devices.

In an example, determining, by the first device based on the one or more response information, identities of the one or more first-type devices may mean that: the first device obtains the identities of the one or more first-type devices from the one or more response information. Correspondingly, the first device generates the first information based on the identities of the one or more first-type devices. That is, the first device directly adds the identities of the one or more first-type devices obtained from the one or more response information to the first information. The first information may only include the identities of the one or more first-type devices. In some embodiments, in the first information, the identities of the one or more first-type devices may be in a form of a list, that is, the first information may include a list of first-type devices.

In this example, generating, by the first device based on the identities of the one or more first-type devices, the first information may further mean that: the first device generates the first information based on the identities of the one or more first-type devices and third information, where the third information includes: an identity of the first service.

Furthermore, the response information may further include information collected by the second device; correspondingly, the first device may obtain information collected by the one or more first-type devices respectively from the one or more response information. So that the third information may further include the information collected by the one or more first-type devices.

In another example, determining, by the first device based on the one or more response information, identities of the one or more first-type devices may mean that: the first device obtains identities of the one or more first-type devices to be detected from the one or more response information, performs identity verification on the identities of the one or more first-type devices to be detected respectively, and takes identities of one or more first-type devices that pass the identity verification as the identities of the one or more first-type devices.

In some embodiments, performing, by the first device, identity verification on the identities of the one or more first-type devices to be detected respectively may include that: the first device performs identity verification on an identity of each of the one or more first-type devices to be detected based on identities of first-type devices corresponding to a service of relay transmission contained in related configuration information corresponding to the service of relay transmission. For example, the first device matches an identity of an i-th first-type device to be detected in the one or more first-type devices to be detected with the identities of the first-type devices corresponding to the service of the relay transmission, in a case where the identity of the i-th first-type device to be detected matches any one of the identities of the first-type devices corresponding to the service of the relay transmission, it is determined that the identity verification for the i-th first-type device to be detected has passed; otherwise, it is determined that the identity verification for the i-th first-type device to be detected has failed. Where i is a positive integer.

Generating, by the first device based on the identities of the one or more first-type devices, the first information may mean: generating, by the first device based on the identities of the one or more first-type devices and the third information, the first information.

The third information includes at least one of: information collected by the one or more first-type devices, an identity of the first service, or indication information of completing identity verification. The relevant descriptions about the information collected by the one or more first-type devices and the identity of the first service are the same as those in above-mentioned examples. In this example, the indication information of completing the identity verification may be represented based on an indication value or indication content. For example, if the indication value of the indication information for completing the identity verification is 100, it may indicate that the first device has completed the identity verification on one or more first-type devices. Otherwise, it may indicate that the first device has not performed the identity verification on the one or more first-type devices. It should be understood that this is an exemplary illustration only and is not intended to limit specific content of the instruction information for completing the identity verification.

In an implementation, the method further includes: transmitting, by the first device, first information, where the first information includes identities of one or more first-type devices; and receiving, by the first device, second information, where the second information includes identities of the one or more authorized first-type devices.

The method further includes: receiving, by the network device, the first information transmitted by the first device, where the first information includes the identities of one or more first-type devices; and determining, by the network device based on the first information, the one or more authorized first-type devices; generating, by the network device based on identities of the one or more authorized first-type devices; and transmitting, by the network device, second information to the first device.

Determining, by the network device based on the first information, the one or more authorized first-type devices includes:
determining, by the network device based on the first information, the one or more authorized first-type devices in a case where the network device determines that the first device is used for relay transmission based on authorization information corresponding to the first device, where the authorization information corresponding to the first device includes an indication of whether the first device is used for relay transmission.

That is, the network device may determine whether the first device is used for relay transmission based on the authorization information corresponding to the first device; if it is determined that the first device is not used for relay transmission, the processing is terminated; if it is determined that the first device is used for relay transmission, the network device determines the one or more authorized first-type devices based on the first information. Where, the content that may be contained in the authorization information corresponding to the first device are the same as the above-mentioned illustration of the authorization information, which will not be repeated here.

Determining, by the network device based on the first information, the one authorized or more authorized first-type devices includes:
determining, by the network device based on preconfiguration information, the one or more authorized first-type devices from the one or more first-type devices included in the first information.

The preconfiguration information includes at least one of:
identities of one or more first-type devices which are allowed to be authorized; or
identities of the one or more first-type devices which are allowed to be authorized under each service in one or more services; or
an information type to be detected under each service in the one or more services.

In an example, the first information may include at least the identities of the one or more first-type devices; correspondingly, the preconfiguration information may include at least the identities of one or more first-type devices which are allowed to be authorized. The network device may determines one or more first-type devices which are allowed to be authorized as the one or more authorized first-type devices based on the identities of one or more first-type devices which are allowed to be authorized, from the one or more first-type devices included in the first information.

For example, the preconfiguration information includes 10 IDs of the first-type devices which are allowed to be authorized, which are first-type device 1 to first-type device 10; the first information includes 5 first-type devices, which are first-type device 1, first-type device 2, first-type device 3, first-type device 11, and first-type device 14; it may be determined that first-type device 1, first-type device 2, and first-type device 3 in the first information are the authorized first-type devices based on the preconfiguration information.

In an example, the first information may include identities of one or more first-type devices and third information; the third information may include an identity of a first service. Accordingly, the preconfiguration information may include at least identities of the one or more first-type devices which are allowed to be authorized under each service in one or more services. The network device may obtain the identities of the one or more first-type devices which are allowed to be authorized under the first service from the preconfiguration information based on the identity of the first service in the first information; and determine one or more first-type devices which are allowed to be authorized from the one or more first-type devices included in the first information as the one or more authorized first-type devices based on the identities of the one or more first-type devices which are allowed to be authorized under the first service.

For example, the network device obtains the identity of the first service from the third information of the first information, obtains IDs of three first-type devices which are allowed to be authorized under the first service from the preconfiguration information based on the identity of the first service, which are first-type device 1, first-type device 3, and first-type device 10; it is assumed that the network device obtains 5 first-type devices from the first information, which are first-type device 1, first-type device 2, first-type device 3, first-type device 11, and first-type device 14, it may be determined that first-type device 1 and first-type device 3 in the first information are authorized first-type devices based on the preconfiguration information.

In an example, the first information may include identities of one or more first-type devices and third information, the third information may include an identity of a first service and information collected by the one or more first-type devices. Accordingly, the preconfiguration information may include at least identities of one or more first-type devices which are allowed to be authorized under each service in one or more services, and further include an information type to be detected under each service in the one or more services. The network device may obtain the identity of the first service based on the third information of the first information, and obtain the identities of the one or more first-type devices which are allowed to be authorized under the first service from the preconfiguration information; determine one or more first-type devices which are allowed to be authorized from the one or more first-type devices included in the first information based on the identities of the one or more first-type devices which are allowed to be authorized under the first service; and determine the authorized first-type device(s) from the one or more first-type devices which are allowed to be authorized based on the information type to be detected under the first service and a type of information collected by the one or more first-type devices which are allowed to be authorized.

For example, the network device obtains the identity of the first service from the third information of the first information, and obtains IDs of three first-type devices which are allowed to be authorized under the first service from the preconfiguration information based on the identity of the first service, which are first-type device 1, first-type device 3, and first-type device 10. It is assumed that the first information contains 5 first-type devices, which are first-type device 1, first-type device 2, first-type device 3, first-type device 11, and first-type device 14; it may be determined that first-type device 1 and first-type device 3 in the first information are the first-type devices which are allowed to be authorized based on the preconfiguration information. It is assumed that the network device obtains that the information collected by the first-type device 1 is humidity information and the information collected by the first-type device 3 is temperature information from the third information of the first information, types of information allowed to be collected by the first-type device 1 contained in the preconfiguration information are humidity information and time information, and a type of information allowed to be collected by the first-type device 3 is temperature information, it may be determined that the first-type device 1 and first-type device 3 are two authorized first-type devices.

After the network device determines the one or more authorized first-type devices, it may generate second information based on the identities of the one or more authorized first-type devices, and then transmit the second information to the first device. Here, the identities of the one or more authorized first-type devices included in the second information may be in a form of a list, that is, the second information may include a list of authorized first-type devices.

The network device that performs the operations of receiving the first information and transmitting the second information may be the above-mentioned third network device.

In an implementation, the method may further includes: transmitting, by the first device, a session establishment request after the first device receives the second information, where the session establishment request is used to request establishment of the session of the first service.

Transmitting, by the first device, the session establishment request may refer to: transmitting, by the first device, the session establishment request to the network device. It should be noted that the network device to which the first device transmits the session establishment request may be the above-mentioned first network device.

The session establishment request is carried by an uplink NAS transmission message.

The uplink NAS transmission message further carries: a parameter of the first service.

In some embodiments, the parameter of the first service may include: a session parameter corresponding to the first service. a method for the first device determining the session parameter corresponding to the first service may be determining the session parameter corresponding to the first service from session parameters corresponding to preconfigured services of relay transmission according to the identity of the first service. The above-mentioned embodiments have described that the session parameter corresponding to the service of relay transmission may include at least one of the DNN corresponding to the service of relay transmission or the S-NSSAI corresponding to the service of relay transmission. Correspondingly, the session parameters of the first service may include at least one of the DNN corresponding to the first service or the S-NSSAI corresponding to the first service.

Furthermore, the parameter of the first service may further include: indication information of a session of a zero power consumption service. The indication information of the session of the zero power consumption service may indicate whether a session established by this request is for a zero power consumption service through an indication value or indication content; for example, if the indication value of the indication information of the session of the zero power consumption service is 10, it may indicate that the session established by this request is for the zero power consumption service; otherwise, it may indicate that the session established by this request is not for the zero power consumption service.

In some embodiments, the parameter of the first service include at least one of: a data network name (DNN) corresponding to the first service, single network slice selection assistance information (S-NSSAI) corresponding to the first service, or indication information of a session of a zero power consumption service.

After completing the above processing, the first device may also receive a session establishment completion notification transmitted by the network device. In a case where the first device receives the session establishment completion notification, the first device may perform above S410, that is, the first device receives the first service information transmitted by the second device; correspondingly, the second device may perform above S610, the second device transmits the first service information to the first device.

Further, the first device may perform S420, the first device transmits the first service information to the network device through the session of the first service; correspondingly, the network device, i.e., the first network device, may perform S510, the network device receives the first service information transmitted by the second device from the first device through the session of the first service; where the second device is one of one or more authorized first-type devices.

Here, the second device may be any one of the one or more authorized first-type devices, that is, any authorized first-type device may transmit the first service information to the first device in a case where the first service information is collected; correspondingly, the first device may transmit the first service information to the network device through the session of the first service in a case where the first service information transmitted by any first-type device is received.

It can be seen that, by adopting above solutions, the first device can transmits the first service information transmitted by the second device to the network device through the session of the first service. In this way, a communication mechanism of transmitting the service information of the second device to the network through an intermediate device can be realized. Thereby, the problem of requiring the second device to communicate directly with the network side which imposes an excessive requirement on power consumption and the like of the second device can be avoided.

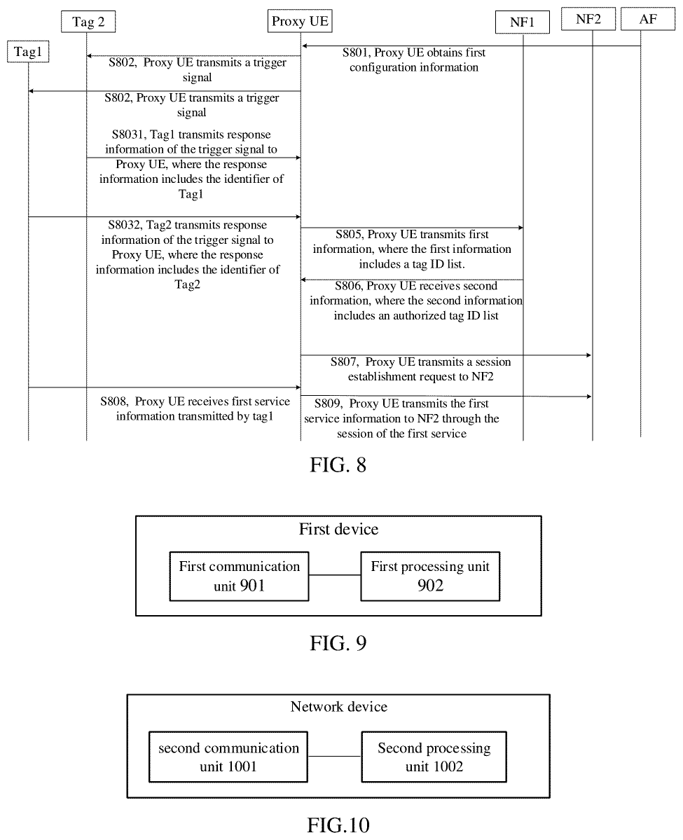

In conjunction with FIG. 8, the first device is referred to as a Proxy UE (user equipment), the first-type devices are referred to as tags, the number of which may be 2, respectively Tag1 and Tag2, and the second device is referred to as Tag1, to exemplarily illustrate the communication method. As shown in FIG. 8, the process of the communication method may include following operations.

S801, Proxy UE obtains first configuration information.

The first configuration information may be preconfigured when Proxy UE produced from the factory, or configured by a second network device; where the second network device may be any core network device, such as the second network device is an AF illustrated in FIG. 8, or may also be a PCF (not shown in the figure). It should be understood that, this is only an illustrative description and is not intended to limit this example.

The first configuration information may include at least one of: authorization information, related configuration information corresponding to services of relay transmission, a first address mapping relationship, or a password mapping relationship. The description of the first configuration information is the same as that in the above-mentioned embodiments, which will not be repeated here.

Similarly, second configuration information may be pre-stored in a first-type device, i.e., Tag, and the second configuration information may include at least an address mapping relationship. The second configuration information may further include at least one of: an identity of Tag, an identity of a service supported by Tag, a verification password used by Tag, an information type supported by Tag, or an identity of a service group to which the service supported by Tag belongs. The description of the second configuration information is the same as that in the above-mentioned embodiments, which will not be repeated here.

S802, Proxy UE transmits a trigger signal.

Exemplarily, if related configuration information corresponding to the services of relay transmission in the first configuration information includes a service area corresponding to the service of relay transmission, Proxy UE may determine whether it is located within a service area corresponding to any one of the services of relay transmissions based on the current location. If Proxy UE is determined to be located within a service area of the first service, a transmission power and/or coverage range of a trigger signal may be determined according to a size of the service area of the first service.

The trigger signal may include a first target L2 identity and a first source L2 identity. The method for determining the first target L2 identity is the same as that in the above-mentioned embodiments, which will not be repeated here. The first source L2 identity (ID) may be allocated by Proxy UE itself. The trigger signal may be a signal of a physical layer which contain no special information and only relies on the L2 identity (ID) (i.e., the first target L2 identity) to distinguish services.

Furthermore, the trigger signal may also include trigger related information; the trigger related information includes at least one of: an ID of Proxy UE, trigger content related information, or indication information used by the first device for relay transmission. The trigger content related information may include at least one of: an identity of the first service (for example, it may be referred to as a service ID), an identity of a service group to which the first service belongs (which may be referred to as a group ID), a target password (i.e., a password used for Tag verification), an information type to be detected in the first service, or the like.

S803, Tag receives the trigger signal transmitted by Proxy UE, and transmits response information of the trigger signal to Proxy UE, where the response information includes an identity of Tag.

In some embodiments, S8031, Tag1 receives the trigger signal transmitted by Proxy UE, and transmits response information of the trigger signal to Proxy UE, where the response information includes an identity of Tag1.

S8032, Tag2 receives the trigger signal transmitted by Proxy UE, and transmits response information of the trigger signal to Proxy UE, where the response information includes an identity of Tag2.

The processing of Tag1 is taken as an example for illustration: Tag1 may transmit the response information of the trigger signal to Proxy UE in a case of determining that a preset condition is met based on the trigger signal. The related description of the preset condition and the determination and processing of Tag1 are the same as those in the above-mentioned embodiments, which will not be repeated here.

The response information transmitted by Tag1 may only include the identity (ID) of Tag1; in addition, the response information may further include information collected by Tag1, the information corresponds to an information type to be detected in the first service. Tag1 may use the first source L2 identity (ID) of Proxy UE, or also use the first target L2 ID of the trigger signal as the second target L2 identity (ID) of the response information; in addition, Tag1 uses its own L2 ID as the second source L2 ID in the response information.

S804, Proxy UE receives two response information of the trigger signal, and determines identities of Tag1 and Tag2 based on the two response information.

In some embodiments, Proxy UE receives two response information using its own first source L2 ID or the configured first target L2 ID as the second target L2 ID. The IDs of Tag1 and Tag2 are obtained from the two response information. In addition, Proxy UE may further obtain information collected by Tag1 and information collected by Tag2 from the two response information respectively.

In addition, if the related configuration information corresponding to the service of relay transmission of the first configuration information contains an identity of a first-type device corresponding to the service of relay transmission (that is, a Tag ID corresponding to the service of relay transmission); Proxy UE checks whether the IDs of Tag1 and Tag2 are in the Tag ID corresponding to the configured service of relay transmission; if they are, Proxy UE may determine that these Tags pass the identity verification.

S805, Proxy UE transmits first information, where the first information includes a tag ID list.

The tag ID list may include the ID of Tag1 and the ID of Tag2.

In some embodiments, Proxy UE takes the received ID of Tag1 and ID of tag2 into a tag ID list in the first information, and transmits the first information to the network device; where the network device may be the third network device in the above-mentioned embodiments, such as NF1 shown in FIG. 8. It should be understood that third configuration information may also be pre-stored on the third network device, i.e., NF1. The definition of the third configuration information is the same as that in the above-mentioned embodiments, which will not be repeated here. And the third configuration information stored on the third network device may also be configured by the second network device. It should be understood that the third network device may be the same as or different from the second network device, which is not limited in the present embodiments.

In addition, if the response information transmitted by tag1 and/or tag2 further includes information collected by tag1 and/or information collected by tag2, the first information may also include the information collected by tag1 and/or information collected by tag2.

Furthermore, if Proxy UE completes the identity verification for tag1 and tag2 and passes this in S804, the first information may further include indication information of the completion of the identity verification.

S806, Proxy UE receives second information, where the second information includes an authorized tag ID list.

In some embodiments, Proxy UE receives the second information transmitted by NF1.

NF1 may determine one or more authorized first-type devices from the one or more first-type devices included in the first information according to preconfiguration information. The processing method is the same as that in the above-mentioned embodiments, which will not be repeated here. The preconfiguration information may be included in the third configuration information, which has also been described in the above-mentioned embodiments, which will not be repeated here.

S807, Proxy UE transmits a session establishment request to NF2. The session establishment request is used to request establishment of a session for the first service.

NF2 may be the first network device. It should be noted that NF2 (i.e., the first network device) and NF1 (i.e., the third network device) may be the same or different. There is exemplary illustration with the difference between NF1 and NF2 in FIG. 8, which does not intend to limit the present embodiments.

In some embodiments, the session establishment request is used to request establishment of a PDU session of the first service. The session establishment request may be carried by a UL NAS transport message. The UL NAS transport message may further carry parameters of a first session, such as a DNN corresponding to the first service, an S-NSSAI corresponding to the first service, and indication information of a zero power consumption service session.

NF2 may perform a session establishment process to establish a session of the first service and zero power consumption service for Proxy UE, until the session establishment is completed, and transmit a notification of session establishment completion to Proxy UE.

S808, Proxy UE receives first service information transmitted by tag1.

Where tag1 may be the second device in the above-mentioned embodiments.

S809, Proxy UE transmits the first service information to NF2 through the session of the first service.

That is, Proxy UE uses the PDU session of the first service to transmit the first service information collected from Tag1 to the network (i.e., NF2).

FIG. 9 is a schematic block diagram of a first device according to an embodiment of the present application. The first device may include:
a first communication unit 901, configured to receive first service information transmitted by a second device; and transmit the first service information to a network device through a session of a first service; where the second device is one of one or more authorized first-type devices.

The first communication unit 901 is configured to transmit first information; where the first information includes identities of one or more first-type devices; and receive second information; where the second information includes identities of the one or more authorized first-type devices.

The first device further includes:
a first processing unit 902, configured to determine identities of the one or more first-type devices based on one or more response information; and generate the first information based on the identities of the one or more first-type devices; where
the first communication unit 901 is configured to transmit a trigger signal, and receive one or more response information of the trigger signal.

The trigger signal includes a first target layer 2 (L2) identity.

The trigger signal further includes trigger related information; where
the trigger related information includes at least one of: an identity of the first device, trigger content related information, or indication information used by the first device for relay transmission.

The trigger content related information includes at least one of: an identity of the first service, an identity of a service group to which the first service belongs, a target password, or an information type to be detected in the first service.

At least one of the identity of the service group to which the first service belongs or the information type to be detected in the first service is preconfigured, or is configured by a network device.

The first target L2 identity is located in a packet header of a MAC layer in a protocol stack of a PC5 interface.

The trigger signal further includes: a first source L2 identity; where the first source L2 identity is located in the packet header of the MAC layer in the protocol stack of the PC5 interface.

The trigger related information is contained in a signaling layer in a protocol stack of a PC5 interface, and the signaling layer is located upper than a MAC layer in the protocol stack of the PC5 interface.

The trigger signal is a signal of a physical layer in a protocol stack of a PC5 interface.

The first processing unit 902 is configured to determine the first target layer 2 (L2) identity based on identity related information corresponding to the first service and a first address mapping relationship; where the first address mapping relationship is preconfigured, or is configured by a network device.

The first processing unit is configured to determine the identity related information corresponding to the first service based on a service area of the first service in a case where the first device is located in the service area of the first service; where the service area of the first service is preconfigured, or is configured by the network device.

The first processing unit is configured to determine the target password based on identity related information corresponding to the first service and a password mapping relationship; where the password mapping relationship is preconfigured, or is configured by a network device.

The first address mapping relationship includes: a mapping relationship between an L2 identity and each identity related information in one or more identity related information configured for the first device.

The password mapping relationship includes: a mapping relationship between a password and each identity related information in one or more identity related information corresponding to the first device.

The identity related information includes one of: an identity of a service, an identity of a service group, or an identity of a first-type device.

The first processing unit is configured to transmit the trigger signal through the first communication unit in a case where the first processing unit determines that itself is used for relay transmission based on authorization information; where the authorization information is preconfigured, or is configured by a network device.

The authorization information includes an indication of whether the first device is used for relay transmission.

The authorization information includes: an identity of a service of relay transmission.

The first processing unit is configured to generate the first information based on the identities of the one or more first-type devices and third information.

The third information includes at least one of: information collected by the one or more first-type devices, an identity of the first service, or indication information of completing identity verification.

The first communication unit is configured to transmit a session establishment request after receiving the second information; where the session establishment request is used to request establishment of the session of the first service.

The session establishment request is carried by an uplink NAS transmission message.

The uplink NAS transmission message further carries a parameter of the first service; where the parameter of the first service includes at least one of: a data network name (DNN) corresponding to the first service, single network slice selection assistance information (S-NSSAI) corresponding to the first service, and indication information of a session of a zero power consumption service.

The session of the first service is a protocol data unit (PDU) session of the first service.

The first service is a zero power consumption service; and/or, a first-type device is a zero power consumption device.

The first device in the embodiments of the present application can implement the corresponding functions of the first device in the method embodiments. The processes, functions, implementation methods and beneficial effects corresponding to each module (sub-module, unit or component, etc.) in the first device can be found in the corresponding description in the above method embodiments, which will not be repeated here. It should be noted that the functions described in the various modules (sub-modules, units or components, etc.) in the first device of the application embodiments can be implemented by different modules (sub-modules, units or components, etc.) or by the same module (sub-module, unit or component, etc.).

FIG. 10 is a schematic block diagram of a network device according to an embodiment of the present application. The network device may include:
a second communication unit 1001, configured to receive first service information transmitted by a second device from a first device through a session of a first service; where the second device is one of one or more authorized first-type devices.

The network device further includes:
a second processing unit 1002, configured to determine the one or more authorized first-type devices based on the first information, and generate second information based on identities of the one or more authorized first-type devices; where
the second communication unit 1001 is configured to receive first information transmitted by the first device, where the first information includes identities of one or more first-type devices, and transmit second information to the first device.

The second processing unit 1002 is configured to determine the one or more authorized first-type devices by the network device based on the first information in a case where the network device determines that the first device is used for relay transmission based on authorization information corresponding to the first device; where the authorization information corresponding to the first device includes an indication of whether the first device is used for relay transmission.

The second processing unit 1002 is configured to determine the one or more authorized first-type devices from the one or more first-type devices included in the first information based on preconfiguration information.

The preconfiguration information includes at least one of:
identities of one or more first-type devices which are allowed to be authorized; or
identities of the one or more first-type devices which are allowed to be authorized under each service in one or more services; or
an information type to be detected under each service in the one or more services.

The session of the first service is a packet data unit (PDU) session of the first service.

The first service is a zero power consumption service; and/or, a first-type device is a zero power consumption device.

FIG. 11 is a schematic block diagram of a second device according to an embodiment of the present application. The second device may include:
a third communication unit 1101, configured to transmit first service information to a first device; where the first service information is transmitted by the first device to a network device through a session of a first service, the second device is one of one or more authorized first-type devices.

The third communication unit 1101 is configured to receive a trigger signal transmitted by the first device, and transmit response information of the trigger signal to the first device, where the response information includes an identity of the second device.

The trigger signal includes a first target L2 identity.

The trigger signal further includes trigger related information;
where the rigger related information includes at least one of: a identity of the first device, trigger content related information, or indication information authorizing the first device to be used for relay transmission.

The trigger content related information includes at least one of: an identity of the first service, an identity of a service group to which the first service belongs, a target password, or an information type to be detected in the first service.

The first target L2 identity is located in a packet header of a MAC layer in a protocol stack of a PC5 interface.

The trigger signal further includes a first source L2 identity, where the first source L2 identity is located in a packet header of a MAC layer in a protocol stack of a PC5 interface.

The trigger related information is contained in a signaling layer in a protocol stack of a PC5 interface, and the signaling layer is located upper than a MAC layer in the protocol stack of the PC5 interface.

The trigger signal is a signal of a physical layer in a protocol stack of a PC5 interface.

The second device further includes:
a third processing unit, configured to transmit the response information of the trigger signal to the first device through the third communication unit in a case where the third processing unit determines that a preset condition is met based on the trigger signal.

The preset condition include at least one of:
identity related information corresponding to the first service matching preconfigured service related information, where the identity related information corresponding to the first service is determined based on a first target L2 identity in the trigger signal and a second address mapping relationship; or
trigger related information in the trigger signal matching the preconfigured service related information.

The second address mapping relationship includes: a mapping relationship between an L2 identity and each identity related information in one or more identity related information configured for the second device.

The identity related information includes one of: an identity of a service, an identity of a service group, or an identity of a first-type device.

The preconfigured service related information includes at least one of: an identity of a service supported by the second device, an identity of a service group to which the service supported by the second device belongs, an identity of the second device, a verification password used by the second device, or an information type supported by the second device.

The response information further includes a second target L2 identity; where the second target L2 identity is the first target L2 identity in the trigger signal, or the first source L2 identity in the trigger signal.

The response information further includes information collected by the second device.

The first service is a zero power consumption service; and/or, a first-type device is a zero power consumption device.

The second device in the embodiments of the present application can implement the corresponding functions of the second device in the method embodiments. The processes, functions, implementation methods and beneficial effects corresponding to each module (sub-module, unit or component, or the like) in the second device can be found in the corresponding description in the above method embodiments, which will not be repeated here. It should be noted that the functions described in each module (sub-module, unit or component, or the like) in the second device of the application embodiments can be implemented by different modules (sub-module, unit or component, or the like) or by the same module (sub-module, unit or component, or the like).

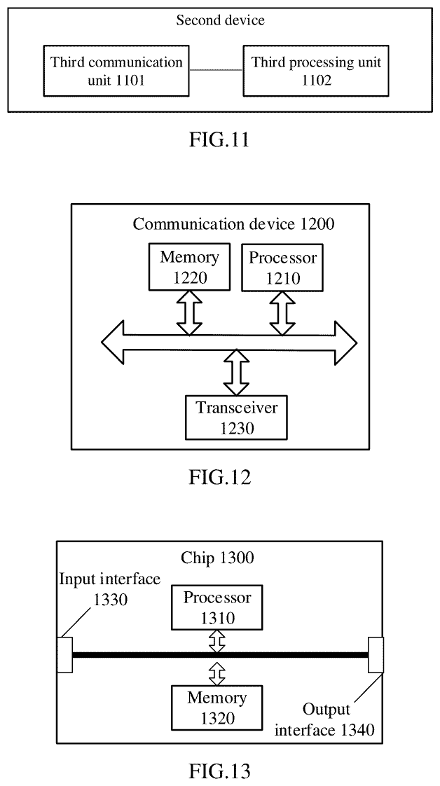

FIG. 12 is a schematic block diagram of a communication device according to embodiments of the present application. The communication device 1200 includes a processor 1210, and the processor 1210 can call a computer program from a memory, and run the computer program, to cause the communication device 1200 to implement the method in the embodiments of the present application.

In an embodiment, the communication device 1200 may further include a memory 1220. The processor 1210 may call a computer program from the memory 1220, and run the computer program, to cause the communication device 1200 implements the method in the embodiments of the present application.

The memory 1220 may be a separate device independent of the processor 1210, or may be integrated into the processor 1210.

In an embodiment, the communication device 1200 may further include a transceiver 1230, and the processor 1210 may control the transceiver 1230 to communicate with other devices, for example, may transmit information or data to other devices, or receive information or data transmitted by other devices.

The transceiver 1230 may include a transmitter and a receiver. The transceiver 1230 may further include an antenna, and the number of the antenna may be one or more.

In an embodiment, the communication device 1200 may be the first device of the embodiments of the present application, and the communication device 1200 may implement the corresponding processes implemented by the first device in each method of the embodiments of the present application, which will not be repeated here for the sake of brevity.

In an embodiment, the communication device 1200 may be a network device of the embodiments of the present application, and the communication device 1200 may implement the corresponding processes implemented by the network device in each method of the embodiments of the present application, which will not be described in detail here for the sake of brevity.

In an embodiment, the communication device 1200 may be the second device of the embodiments of the present application, and the communication device 1200 may implement the corresponding processes implemented by the second device in each method of the embodiments of the present application, which will not be repeated here for the sake of brevity.

FIG. 13 is a schematic structural diagram of a chip 1300 according to embodiments of the present application. The chip 1300 includes a processor 1310, which can call a computer program from a memory, and run the computer program, to implement the method in the embodiments of the present application.

In an implementation, the chip 1300 may further include a memory 1320. Where the processor 1310 can call a computer program from the memory 1320, and run the computer program, to implement the method performed by the first device, the network device, or the second device in the embodiments of the present application.

The memory 1320 may be a separate device independent of the processor 1310, or may be integrated into the processor 1310.

In an implementation, the chip 1300 may further include an input interface 1330. The processor 1310 may control the input interface 1330 to communicate with other devices or chips, and for example, may obtain information or data transmitted by other devices or chips.

In an embodiment, the chip 1300 may further include an output interface 1340. The processor 1310 may control the output interface 1340 to communicate with other devices or chips, and for example, may output information or data to other devices or chips.

In an implementation, the chip can be applied to the first device in the embodiments of the present application, and the chip can implement the corresponding processes implemented by the first device in each method of the embodiments of the present application, which will not be repeated here for the sake of brevity.

In an embodiment, the chip can be applied to the second device in the embodiments of the present application, and the chip can implement the corresponding processes implemented by the second device in each method of the embodiments of the present application, which will not be repeated here for the sake of brevity.

The chips applied to the first device and the second device may be the same chip or different chips.

It should be understood that the chip mentioned in the embodiments of the present application may be referred to as a system-level chip, a system chip, a chip system, a system-on-chip, or the like.

The processor mentioned above may be a general-purpose processor, a digital signal processor (DSP), a field programmable gate array (FPGA), an application specific integrated circuit (ASIC) or other programmable logic devices, transistor logic devices, discrete hardware components, etc. The general purpose processor mentioned above may be a microprocessor or any conventional processor.

The memory mentioned above may be a volatile (transitory) memory or a non-volatile (non-transitory) memory, or may include both the volatile memory and non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a random access memory (RAM).

It should be understood that the above memory is exemplary but not limited illustration. For example, the memory in the embodiments of the present application may also be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct Rambus random access memory (Direct Rambus RAM, DR RAM), etc. That is, the memory in the embodiments of the present application is intended to include, but not limited to, these and any other suitable types of memories.

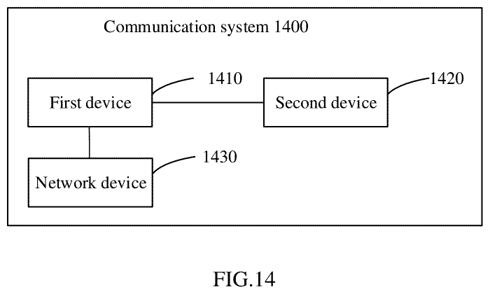

FIG. 14 is a schematic block diagram of a communication system 1400 according to the embodiments of the present application. The communication system 1400 includes a first device 1410, a second device 1420, and a network device 1430.

The first device 1410 is configured to perform the above communication method; the second device 1420 is configured to perform the above communication method; the network device 1430 is configured to perform the above communication method.

The first device 1410 may be configured to implement the corresponding functions implemented by the first device in the above methods, the network device 1430 may be configured to implement the corresponding functions implemented by the network device in the above methods, and the second device 1420 may be configured to implement the corresponding functions implemented by the second device in the above methods, which will not be repeated here for the sake of brevity.

In the above embodiments, all or part of them may be implemented by software, hardware, firmware or any combination thereof. When implemented using software, all or part of the implementation may be in the form of a computer program product. The computer program product includes one or more computer instructions. When the computer program instructions are loaded and executed on a computer, the processes or functions in the embodiments of the present application are generated in whole or in part. The computer may be a general purpose computer, a special purpose computer, a computer network, or other programmable device. The computer instructions may be stored in a non-transitory computer-readable storage medium, or transmitted from one non-transitory computer-readable storage medium to another non-transitory non-transitory computer-readable storage medium. For example, the computer instructions may be transmitted from one website, computer, server, or data center to another website, computer, server, or data center via wired (e.g., coaxial cable, optical fiber, digital subscriber line (DSL)) or wireless (e.g., infrared, wireless, microwave, or the like) means. The non-transitory computer-readable storage medium may be any available medium that can be accessed by a computer or a data storage device such as a server or a data center that includes one or more available media. The available medium may be a magnetic medium (e.g., a floppy disk, a hard disk, a magnetic tape), an optical medium (e.g., a DVD), or a semiconductor medium (e.g., a solid state disk (SSD)).

It should be understood that in the various embodiments of the present application, the size of the serial numbers of the above-mentioned processes does not mean the order of execution. The execution order of each process should be determined by its function and internal logic, and should not constitute any limitation on the implementation process of the embodiments of the present application.

Those skilled in the art may clearly understand that for the convenience and brevity of the description, the operating processes of the system, apparatus and unit described above may refer to the corresponding procedures in the embodiments of the method above, and will not be repeated here.

The foregoing descriptions are merely exemplary implementations of the present application, but the protection scope of the present application is not limited thereto. Any skilled person in the art could readily conceive of changes or replacements within the technical scope of the present application, which shall be all included in the protection scope of the present application. Therefore, the protection scope of the present application shall be subject to the protection scope of claims.

What is claimed is:

1. A first device, comprising: a processor and a memory, wherein the memory is configured to store a computer program, the processor is configured to call the computer program stored in the memory and run the computer program, to cause the first device to perform:
receiving first service information transmitted by a second device, wherein the second device is one of one or more authorized first-type devices; and
transmitting, through a session of a first service, the first service information to a network device.

2. The first device of claim 1, wherein the first device further performs:
transmitting first information, wherein the first information comprises identities of one or more first-type devices; and
receiving second information, wherein the second information comprises identities of the one or more authorized first-type devices.

3. The first device of claim 2, wherein the first device further performs:
transmitting a trigger signal;
receiving one or more response information of the trigger signal;
determining, based on the one or more response information, identities of the one or more first-type devices; and
generating, based on the identities of the one or more first-type devices, the first information.

4. The first device of claim 3, wherein the trigger signal comprises a first target layer 2 (L2) identity and/or trigger related information; wherein
the trigger related information comprises at least one of: an identity of the first device, trigger content related information, or indication information used by the first device for relay transmission;
wherein the trigger content related information comprises at least one of: an identity of the first service, an identity of a service group to which the first service belongs, a target password, or an information type to be detected in the first service.

5. The first device of claim 4, wherein the trigger related information is contained in a signaling layer in a protocol stack of a PC5 interface, and the signaling layer is located upper than a MAC layer in the protocol stack of the PC5 interface.

6. The first device of claim 3, wherein the trigger signal comprises a first target layer 2 (L2) identity and/or a first source L2 identity; wherein
the first target L2 identity is located in a packet header of a MAC layer in a protocol stack of a PC5 interface, the first source L2 identity is located in the packet header of the MAC layer in the protocol stack of the PC5 interface.

7. The first device of claim 4, wherein the first device further performs:
determining, based on identity related information corresponding to the first service and a first address mapping relationship, the first target layer 2 (L2) identity, wherein the first address mapping relationship is preconfigured, or is configured by a network device;
wherein the first device further performs:
determining, based on a service area of the first service, the identity related information corresponding to the first service in a case where the first device is located in the service area of the first service, wherein the service area of the first service is preconfigured, or is configured by the network device.

8. The first device of claim 3, wherein the first device performs:
generating, based on the identities of the one or more first-type devices and third information, the first information.

9. The first device of claim 2, wherein the first device further performs:
transmitting an uplink NAS transmission message after the first device receives the second information, wherein the uplink NAS transmission message carries a session establishment request and/or a parameter of the first service, the session establishment request is used to request establishment of the session of the first service;
wherein the parameter of the first service comprise at least one of: a data network name (DNN) corresponding to the first service, single network slice selection assistance information (S-NSSAI) corresponding to the first service, or indication information of a session of a zero power consumption service.

10. The first device of claim 4, wherein the first device further performs:
determining, based on identity related information corresponding to the first service and a password mapping relationship, the target password, wherein the password mapping relationship is preconfigured, or is configured by a network device;
wherein the password mapping relationship comprises a mapping relationship between a password and each identity related information in one or more identity related information corresponding to the first device; and
the identity related information comprises one of: an identity of a service, an identity of a service group, or an identity of a first-type device.

11. A network device, comprising: a processor and a memory, wherein the memory is configured to store a computer program, the processor is configured to call the computer program stored in the memory and run the computer program, to cause the second device to perform:
receiving, through a session of a first service, first service information transmitted by a second device from a first device, wherein the second device is one of one or more authorized first-type devices.

12. The network device of claim 11, wherein the network device further performs:
receiving first information transmitted by the first device, wherein the first information comprises identities of one or more first-type devices; and
determining, based on the first information, the one or more authorized first-type devices;
generating, based on identities of the one or more authorized first-type devices, second information; and
transmitting second information to the first device.

13. The network device of claim 12, wherein the network device performs:
determining, based on the first information, the one or more authorized first-type devices in a case where the network device determines that the first device is used for relay transmission based on authorization information corresponding to the first device, wherein the authorization information corresponding to the first device comprises an indication of whether the first device is used for relay transmission.

14. The network device of claim 12, wherein the network device performs:
determining, based on preconfiguration information, the one or more authorized first-type devices from the one or more first-type devices comprised in the first information;
wherein the preconfiguration information comprises at least one of:
identities of one or more first-type devices which are allowed to be authorized;
identities of the one or more first-type devices which are allowed to be authorized under each service in one or more services; or
an information type to be detected under each service in the one or more services.

15. A second device, comprising: a processor and a memory, wherein the memory is configured to store a computer program, the processor is configured to call the computer program stored in the memory and run the computer program, to cause the second device to perform:
transmitting first service information to a first device, wherein the first service information is transmitted by the first device to a network device through a session of a first service, and the second device is one of one or more authorized first-type devices.

16. The second device of claim 15, wherein the second device further performs:
receiving a trigger signal transmitted by the first device; and
transmitting response information of the trigger signal to the first device, wherein the response information comprises an identity of the second device.

17. The second device of claim 16, wherein the trigger signal comprises a first target L2 identity and/or trigger related information; wherein
the trigger related information comprises at least one of: an identity of the first device, trigger content related information, or indication information used by the first device for relay transmission;
wherein the trigger content related information comprises at least one of: an identity of the first service, an identity of a service group to which the first service belongs, a target password, or an information type to be detected in the first service.

18. The second device of claim 17, wherein the trigger related information is contained in a signaling layer in a protocol stack of a PC5 interface, and the signaling layer is located upper than a MAC layer in the protocol stack of the PC5 interface.

19. The second device of claim 17, wherein the first target L2 identity is located in a packet header of a MAC layer in a protocol stack of a PC5 interface;
wherein the trigger signal further comprises a first source L2 identity, wherein the first source L2 identity is located in a packet header of a MAC layer in a protocol stack of a PC5 interface.

20. The second device of claim 16, wherein the second device performs:
transmitting the response information of the trigger signal to the first device in a case where the second device determines that a preset condition is met based on the trigger signal;
wherein the preset condition comprises at least one of:
identity related information corresponding to the first service matching preconfigured service related information, wherein the identity related information corresponding to the first service is determined based on a first target L2 identity in the trigger signal and a second address mapping relationship; or
trigger related information in the trigger signal matching the preconfigured service related information.
